(19) United States
(12) Patent Application Publication
(10) Pub. No.: US 2015/0163679 A1
(43) Pub. Date: Jun. 11, 2015

(54) WIRELESS COMMUNICATION SYSTEM USING HYBRID COOPERATIVE AND NONCOOPERATIVE SENSING

(71) Applicant: Abdullah Masoud M. ALMASOUD, Ames, IA (US)

(72) Inventor: Abdullah Masoud M. ALMASOUD, Ames, IA (US)

(21) Appl. No.: 14/099,730

(22) Filed: Dec. 6, 2013

(51) Int. Cl. H04W 16/14; H04W 48/16

(52) U.S. Cl. CPC H04W 16/14; H04W 48/16; H04W 48/10

(57) ABSTRACT

A combination of cooperative and non-cooperative sensing methods improves spectrum utilization by switching network nodes not interfering with both primary system and cooperative secondary users to non-cooperative mode. The method then keeps record of the number of times the result of spectrum sensing of a network node matches or differs from the result of cooperative sensing. Also, the method sets thresholds to shift register values to determine when to switch back and forth between cooperative and non cooperative sensing modes, and sending control messages to let a non cooperative user access the spectrum. In the present disclosure two antenna are considered for each network node to separate the two types of control messages or broadcast and reply messages.

### GRANT OF NON-EXCLUSIVE RIGHT

This application was prepared with financial support from the Saudi Arabian Cultural Mission, and in consideration therefore the present inventor(s) has granted The Kingdom of Saudi Arabia a non-exclusive right to practice the present invention.

### TECHNICAL FIELD

The present disclosure relates to hybrid cooperative and non-cooperative sensing in wireless networks.

### DESCRIPTION OF THE RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In cooperative sensing, all users, or cognitive radios (CRs), sense the spectrum, and send their observation of the status of the spectrum to a central entity (such as a base station or lead CR) that makes a decision based on voting results. One example may be majority vote on the observation of CRs. Then, the central entity sends the result back to all CRs. CRs receive the spectrum decision from the central entity and follow that decision. The voting is accumulated at a fusion center.

However, it may happen that for example in a wireless network with six cognitive radios, five cognitive radios are blocked due to interference from a transmitting primary user. All six CRs will cooperate in the sensing process during which the first five CRs find the spectrum to be busy and CR6 finds that the spectrum is idle. The voting, for example majority voting, of spectrum voting process will indicate that the spectrum is busy, and hence, CR6, which is not under the influence of primary user or is not interfering with the primary user, cannot use the spectrum, due to the vote of other five CRs even though the spectrum is really available for CR6.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

A combination of cooperative and non-cooperative sensing methods is disclosed, which improves spectrum utilization by switching network nodes not interfering with both primary system and cooperative secondary CRs to a non-cooperative mode. The method then keeps record of the number of times the result of spectrum sensing of a network node matches or differs from the result of cooperative sensing. Also, the method sets thresholds in shift registers to determine when to switch back and forth between cooperative and non cooperative sensing modes, and sends control messages to let a non cooperative CR access the spectrum.

The present disclosure uses two antenna for each network node to separate the two types of control messages or broadcast and reply messages.

### BRIEF DESCRIPTION OF THE DRAWINGS

The disclosure will be better understood from reading the description which follows and from examining the accompanying figures. These are provided solely as non-limiting examples of embodiments. In the drawings:

FIG. 1 is an example cognitive radio network that uses cooperative spectrum sensing with cognitive radios;

FIG. 2 is a block diagram that shows a voting flow in the fusion center or central entity;

FIG. 3 is a diagram of a network that shows feedback messages from neighbors of a CR6 sent to the CR6;

FIG. 4 is a diagram of a network that shows a CR6 affecting or interfering with only one cooperative CR;

FIG. 5 is a diagram of a network that shows CR6 discovering that there is no primary or cooperative CRs which will be affected by the transmission from CR6;

FIG. 6 is a flow chart that shows the mechanism for protecting a primary system and cooperative CRs from interference by a non-cooperative CR 6;

FIG. 7 is a flow chart that shows using a shift register and a threshold by a CR to determine when to switch to non-cooperative mode;

FIG. 8 is a diagram that shows how the value of a shift register of a non-cooperative user is incremented; and

FIG. 9 is a block diagram of a computer system upon which an embodiment of the present invention may be implemented.

### DETAILED DESCRIPTION

The description provided here is intended to enable any person skilled in the art to understand, make and use this invention. Various modifications to the disclosed embodiments will be readily apparent to those skilled in the art, and the general principals defined herein may be applied to these modified embodiments and applications without departing from the scope of this invention. In each of the embodiment, the various actions could be performed by program instruction running on one or more processors, by specialized circuitry or by a combination of both. Moreover, the invention can additionally be considered to be embodied, entirely or partially, within any form of computer readable carrier containing instructions that will cause the executing device to carry out the technique disclosed herein. The present invention is thus, not intended to be limited to the disclosed embodiments, rather it is be accorded the widest scope consistent with the principles and features disclosed herein.

Details of functions and configurations well known to a person skilled in this art are omitted to make the description of the present invention clear. The same drawing reference numerals will be understood to refer to the same elements throughout the drawings.

The present disclosure may be applied to any type of wireless network. One aspect of the present disclosure includes a type of wireless networks called cognitive radio (CR) networks only for the purpose of explanation.

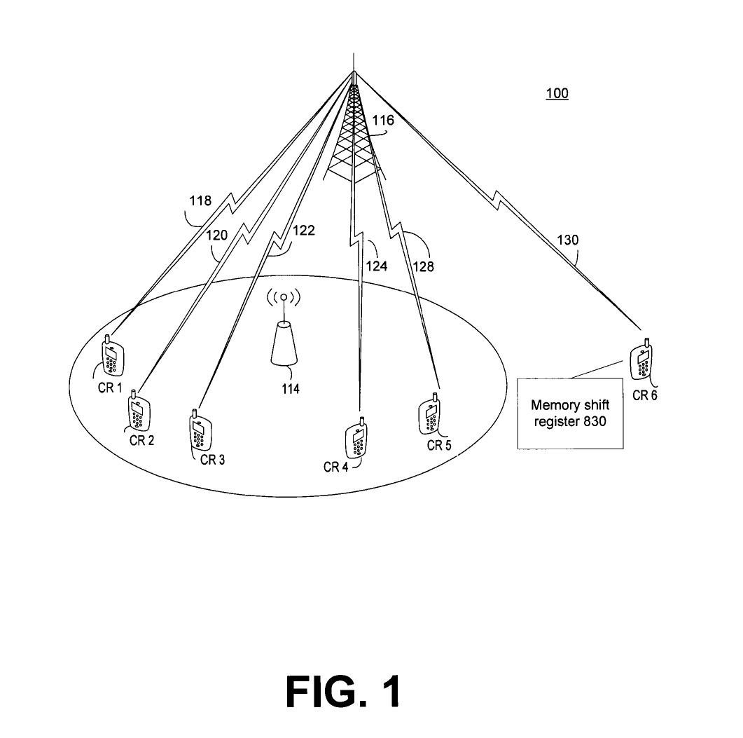

FIG. 1 illustrates an example of a cooperative spectrum sensing system. There are a plurality of cognitive radios (CR1-CR6) cooperating in spectrum sensing.

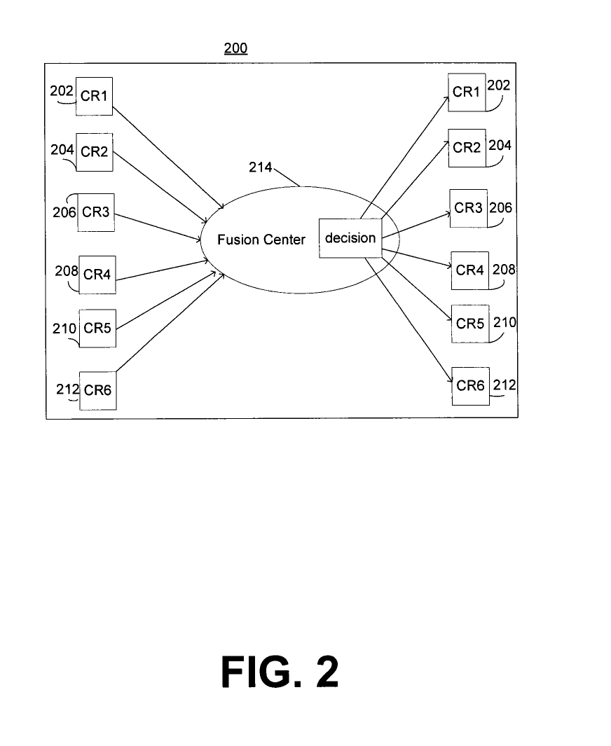

Moreover, FIG. 1 illustrates a non-limiting example of a cooperative spectrum sensing, in which there are a plurality of cognitive radios (CRs) CR 1 to CR 6 cooperating in spectrum sensing. A base station 116 communicates wirelessly with CRs CR 1 to CR 6 through sending signals 118-130. In FIG. 1, there is also a primary user 114. A fusion center 214 (in FIG. 2) may also be included in base station 116.

FIG. 2 is a block diagram of a non-limiting example of a cooperative spectrum sensing system, according to certain embodiments. There is a plurality of cognitive radios (CRs) CR 1 to CR 6 (202-212) cooperating in spectrum sensing as shown in FIG. 2. CRs 202 to 212 in FIG. 2 send their spectrum sensing results or votes to the fusion center 214. The fusion center 214 then combines the votes and makes a decision. The voting results may be obtained by different rules, for example majority voting rule. The fusion center 214 then sends the decision to CRs 202 to 212 to inform them whether the spectrum is available or not.

Returning to FIG. 1, for example CR6 may observe the spectrum status to be different than the other cooperative CR's, because CR6 is far away from the transmission footprint of primary user 114. As a result, if CR6 uses the spectrum, it may not cause any interference to the primary user 114 or other cooperative CRs CR 1 to CR 5. In this example, CR6 should switch to non-cooperative sensing since it is far away from the other five cooperative CRs CR 1 to CR 6 and the primary user 114, and it will not cause interference to them if it uses the spectrum. Hence, the present disclosure provides improvement of spectrum utilization by allowing CRs to opt-in or opt-out of cooperative sensing based on detection of mutual interference.

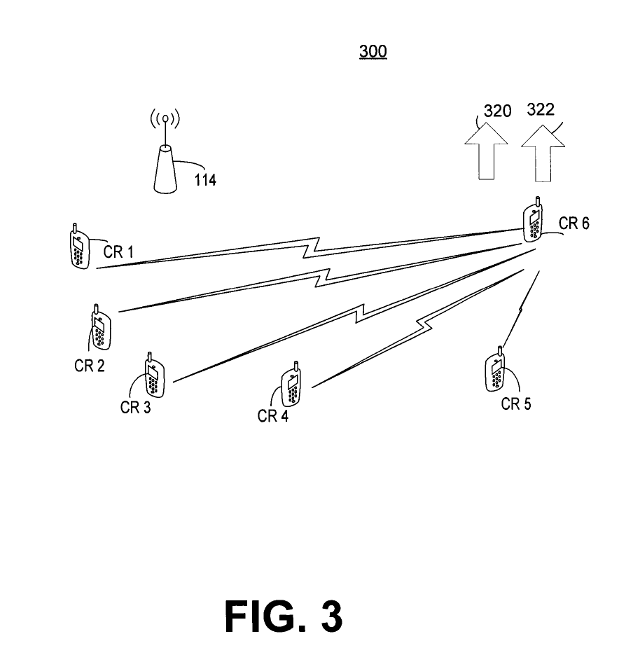

In one embodiment, referring to FIG. 3, the present disclosure utilizes two antennas for each CR 1 to CR 6: one antenna 320 is configured for transmission over a certain channel and the other antenna 322 is configured to send control messages, comprising the broadcast message and the replies, over a control channel. The reason for this control channel is to prevent the broadcast message sent by a non-cooperative CR to cause any interference to a primary user or a cooperative CR. Control messages allow non-cooperative CRs to access the spectrum at the right time and place while achieving the coexistence of cooperative and non-cooperative CRs.

FIG. 3 illustrates a non-limiting example of feedback messages from neighboring CRs 1 to CR 5 of a CR6 sent to the CR6. The feedback messages, in this example, inform the CR6 that its transmission will cause interference to a primary user 114 and some cooperative CRs. Hence, according to the present disclosure, CR6 must avoid accessing the spectrum in this situation, and heeds the warnings in the feedback messages.

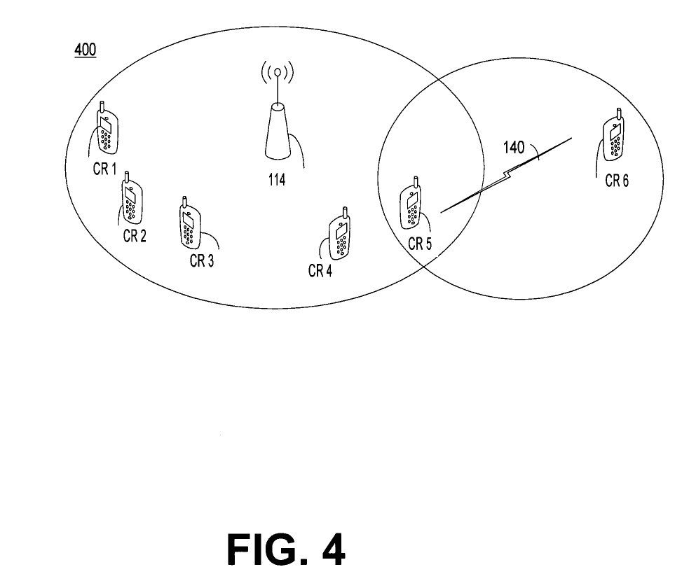

Referring now to FIG. 4, FIG. 4 illustrates a non-limiting example of a CR 6 affecting or interfering with only one cooperative CR or a CR 5 with interference signal 140. As a result, in one embodiment, according to the present disclosure CR 6 should avoid accessing the spectrum, in this example.

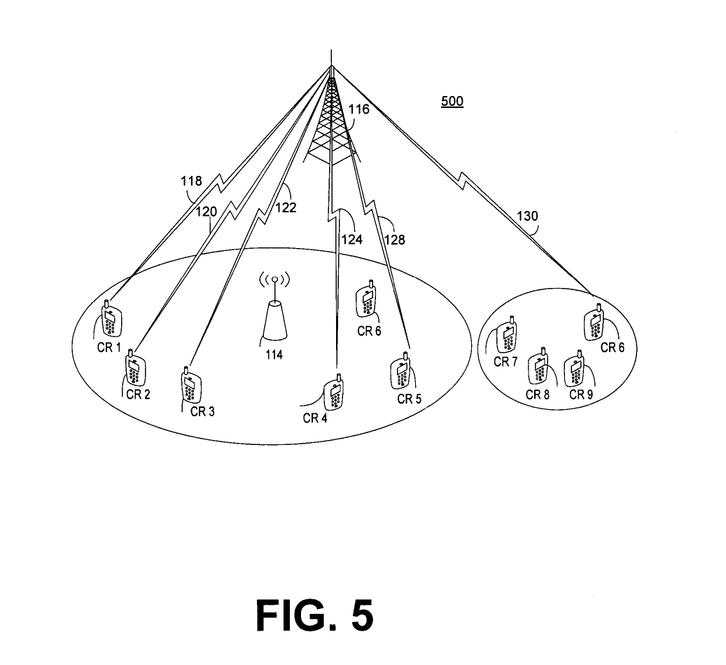

Referring now to FIG. 5, FIG. 5 illustrates a non-limiting example of CR6 discovering that the transmission from CR 6 will not affect the primary user 114 or cooperative CRs CR 1 to CR 5. Hence, in the embodiment CR6 uses the spectrum and transmits to CR 7, CR 8 and CR 9 even though a primary user 114 and/or a plurality of cooperative CRs CR1 to CR5 are also using the spectrum. According to one embodiment, the present disclosure improves spectrum utilization by this coexistence of cooperative and non-cooperative CRs' transmissions.

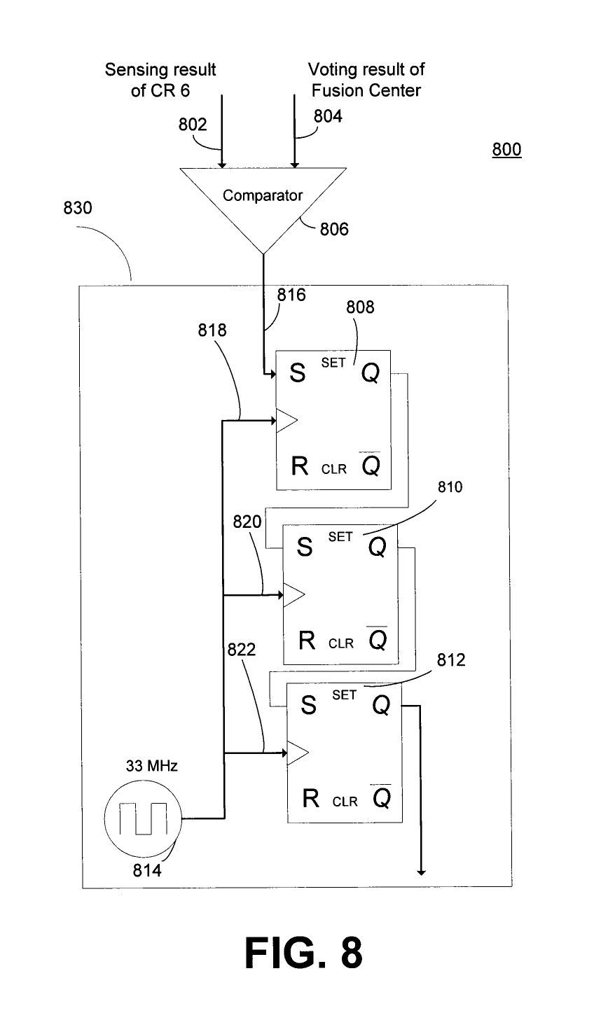

CR 6 may suffer from intermittent failure due to hardware or software temporal failure, or also because of a temporal obstacle. As a result, switching CR 6 immediately to non-cooperative sensing after any spectrum sensing observation, which mismatches with the voting result, should be avoided. Hence, referring to FIG. 1, the present disclosure uses a memory, for example shift register 830 at CR 6 and memories for every CR to record if the sensing results of local spectrum observation and the voting result of fusion center 214 in FIG. 2 match or not. The elements of memory or shift register 830 are explained in detail, later in this disclosure, when referring to FIG. 8. If the memory of a CR6 indicates that the CR6's spectrum observations are not matching the voting results for a certain number of times or a threshold value, for example 5, then the CR should switch to non-cooperative sensing. In one embodiment, the present disclosure continues comparing the local observation of the user with the voting result even while the CR user is operating under non-cooperative sensing. Once the number of local observations in the shift register matching the voting results reaches a certain threshold, the CR switches back to cooperative sensing to increase the robustness of the voting process.

Non-limiting examples of a primary user or primary system in this disclosure may be a base station, and Television white spaces. Since a non-cooperative CR may suffer from shadowing or fading, it is important to protect a primary user and cooperative cognitive CRs from the interference that may be caused by the non-cooperative CR. Hence, a non-cooperative CR must make sure that its transmission does not affect the primary user or cooperative CRs at a harmful level. To accomplish that, the present disclosure provides the following steps for a non-cooperative CR. In one embodiment, the present disclosure directs a non-cooperative CR to first sense the spectrum to find whether it is available or not. Once it finds that the spectrum is available, according to one embodiment, the present disclosure directs the CR to send a broadcast message to all its neighboring CRs to inform them about its intention to access the spectrum and to enquire if that is possible. According to one embodiment, the present disclosure maintains that each neighbor receiving the message will reply with a message indicating its expectation about whether the transmission from the non-cooperative CR will cause harmful interference to the neighbor node or primary user or not. If all neighbors indicate that no harmful interference will be caused by the non-cooperative CR to them or to the primary user, then the present disclosure, directs the non-cooperative CR to use the spectrum.

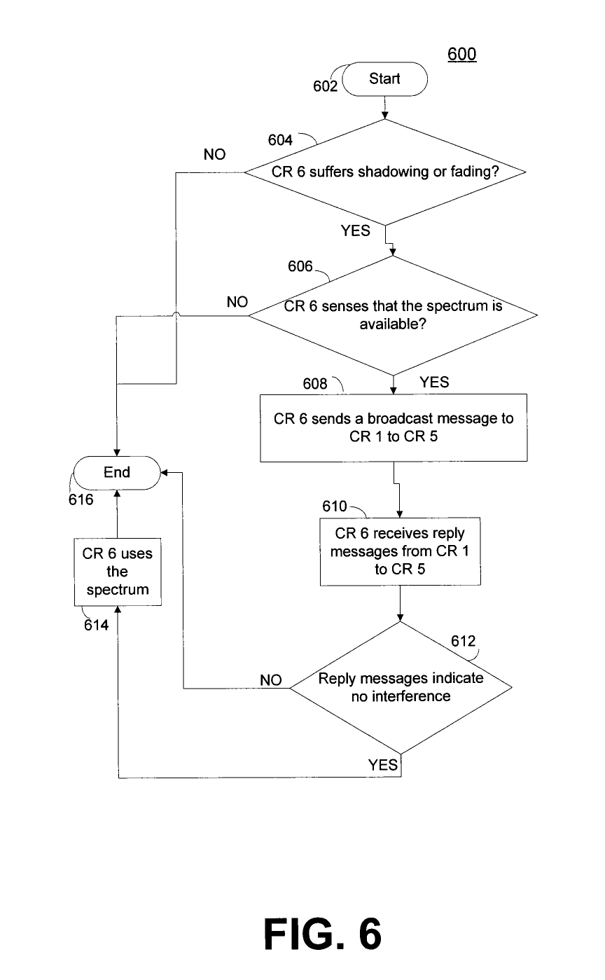

Referring now to FIG. 6, FIG. 6 illustrates a non-limiting example of a primary user and cooperative CRs being protected from interference from a non-cooperative CR. In FIG. 6, CR 6 checks a condition 604 on whether the CR 6 is suffering shadowing or fading. If condition 604 is not met, no action is taken. If condition 604 is true then condition 606 checks if the CR 6 senses that the spectrum is available. If condition 606 is false, then no action is taken. If condition 606 is true, then, in step 608, CR 6 sends a broadcast message to CR 1 to CR 5. In step 608, CR 6 receives reply messages from CR 1 to CR 5 and checks condition 612 to find out whether reply messages indicate no interference. If condition 612 is false, CR 6 does not transmit. If condition 612 is true, CR 6 uses the spectrum. This happens because the primary user and the neighboring CRs may be idle or far away from the effects caused by the non-cooperative CR6's transmission.

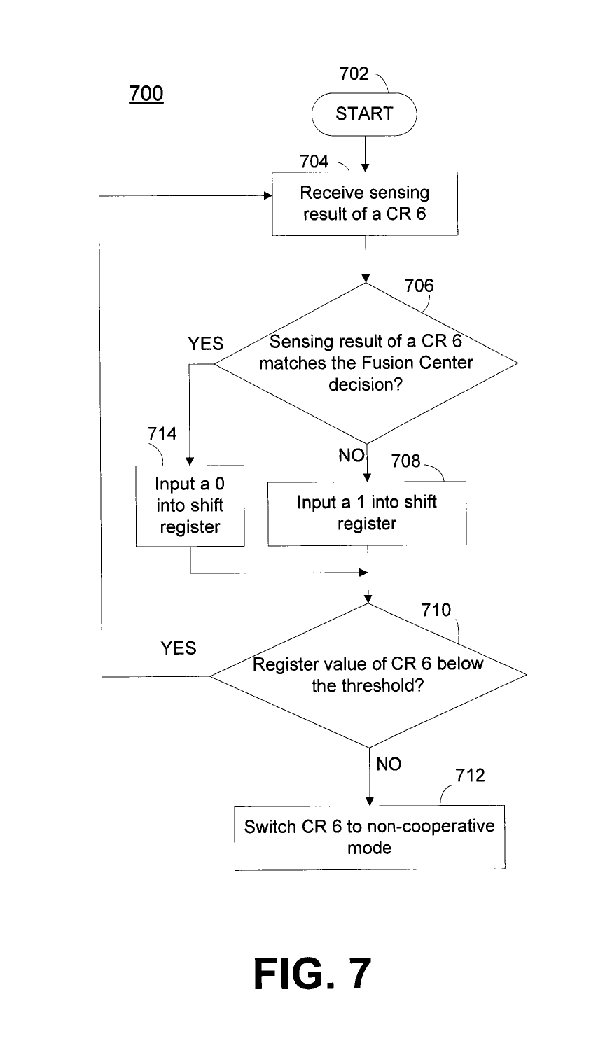

Referring now to FIG. 7, FIG. 7 illustrates a non-limiting example of a flowchart using a shift register and a threshold at a CR 6 to determine when the CR 6 should switch to the non-cooperative mode, according to certain embodiments.

In FIG. 7 in module 704 a CR 6 senses the spectrum and also receives the decision made by fusion center 214 in FIG. 2. Then condition 706 is checked to find out whether the sensing result of the CR 6 matches the decision of the fusion center. If the sensing result of CR 6 is different from the fusion center decision, then a 1 is entered into shift register of CR 6 in module 708. If condition 706 is met, in step 714 a 0 is entered into shift register of CR 6. In condition 710 of FIG. 7 it is checked if the value of the shift register of CR 6 is below a predefined threshold, for example 5. If condition 710 is met, the process returns to step 704. If condition 710 is not true, CR 6 switches to non-cooperative mode.

Referring now to FIG. 8, FIG. 8 illustrates a non-limiting example of a how the shift register of CR 6 is used in the flow chart of FIG. 7, according to certain embodiments.

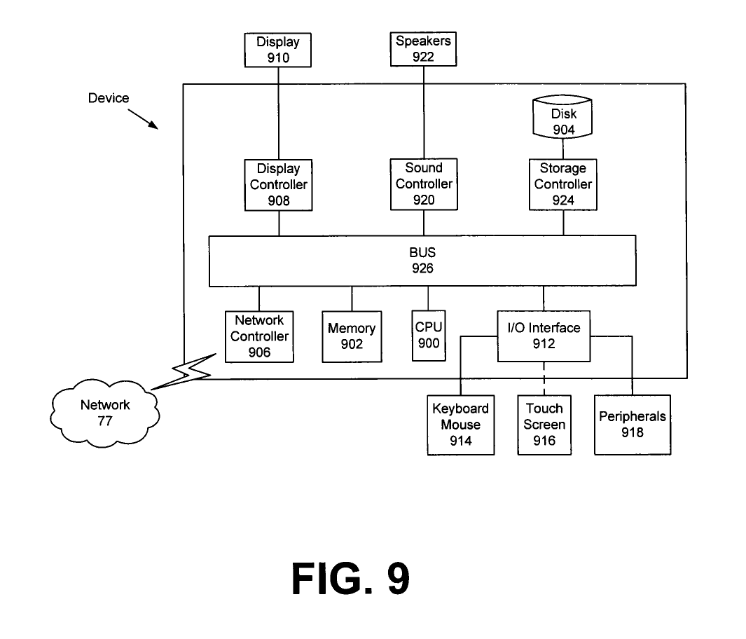

In FIG. 8 a sensing result of CR 6 802 and a voting result of fusion center or 804 are inputs to comparator 806. The output 816 of comparator 806 is input to a shift register 830 as an input to flip flop 816. The shift register 830 comprises three flip flops 808, 810, and 812. The flip flops 818, 810, and 812 are connected to clock 814 signal. The clock 814 signal connected to flip flop 808 is denoted by 818. The clock 814 signal connected to flip flop 810 is denoted by 8120. The clock 814 signal connected to flip flop 812 is denoted by 822. The clock 814 operates at 33 MHz. The purpose of the shift register 830 is to count the number of mismatches within a number of sensing samples. The shift register 830 is initially is set to zero. Each time the comparator output 816 is a one, a 1 is entered into the shift register 830 to keep record of the number of times the sensing result of CR 6 is different from the voting result of the fusion center. Each time the comparator output 816 is a 0, a 0 is entered into the shift register 830. Processing circuitry, such as that described in FIG. 9 may be used as an alternative to the shift register and discrete logic that performs the comparison. For example, if shift register 830 has 10 bits instead of 3 bits, and if the mismatch threshold is 6, then CR 6 switches to non-cooperative mode if there are 6 bits with value 1 in the shift register 830 and the CR 6 switches back to cooperative mode, if there are 5 bits with value 0. This makes this method invulnerable to intermittent failure, because according to one embodiment of this disclosure, the CR 6 switches to the non-cooperative mode only if the local sensing result of CR 6 mismatches the voting result within a certain number of sensing samples, and compared to a certain value of mismatch threshold.

In one embodiment, the present disclosure improves spectrum utilization by letting CRs which are blocked from using the spectrum, due to cooperative sensing mode, utilize the available resources without causing interference to a primary user or other CRs.

In another embodiment, the present disclosure is a hybrid or a combination of cooperative and non-cooperative spectrum sensing.

In another embodiment, the present disclosure mitigates the drawbacks of cooperative sensing in some cases.

Next, a hardware description of a device according to exemplary embodiments is described with reference to FIG. 9. In FIG. 9, the device includes a CPU 900 which performs the processes described above. The process data and instructions may be stored in memory 902. These processes and instructions may also be stored on a storage medium disk 904 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device communicates, such as a server or computer.

Further, the claimed advancements may be provided as a utility application, background daemon, or component of an operating system, or combination thereof, executing in conjunction with CPU 900 and an operating system such as Microsoft Windows 7, UNIX, Solaris, LINUX, Apple MAC-OS and other systems known to those skilled in the art.

CPU 900 may be a Xenon or Core processor from Intel of America or an Opteron processor from AMD of America, or may be other processor types that would be recognized by one of ordinary skill in the art. Alternatively, the CPU 900 may be implemented on an FPGA, ASIC, PLD or using discrete logic circuits, as one of ordinary skill in the art would recognize. Further, CPU 900 may be implemented as multiple processors cooperatively working in parallel to perform the instructions of the inventive processes described above.

The device in FIG. 9 also includes a network controller 906, such as an Intel Ethernet PRO network interface card from Intel Corporation of America, for interfacing with network 77. As can be appreciated, the network 77 can be a public network, such as the Internet, or a private network such as an LAN or WAN network, or any combination thereof and can also include PSTN or ISDN sub-networks. The network 77 can also be wired, such as an Ethernet network, or can be wireless such as a cellular network including EDGE, 3G and 4G wireless cellular systems. The wireless network can also be WiFi, Bluetooth, or any other wireless form of communication that is known.

The device further includes a display controller 908, such as a NVIDIA GeForce GTX or Quadro graphics adaptor from NVIDIA Corporation of America for interfacing with display 910, such as a Hewlett Packard HPL2445w LCD monitor. A general purpose I/O interface 912 interfaces with a keyboard and/or mouse 914 as well as a touch screen panel 916 on or separate from display 910. General purpose I/O interface also connects to a variety of peripherals 918 including printers and scanners, such as an OfficeJet or DeskJet from Hewlett Packard.

A sound controller 920 is also provided in the device, such as Sound Blaster X-Fi Titanium from Creative, to interface with speakers/microphone 922 thereby providing sounds and/or music.

The general purpose storage controller 924 connects the storage medium disk 904 with communication bus 926, which may be an ISA, EISA, VESA, PCI, or similar, for interconnecting all of the components of the device. A description of the general features and functionality of the display 910, keyboard and/or mouse 914, as well as the display controller 908, storage controller 924, network controller 906, sound controller 920, and general purpose I/O interface 912 is omitted herein for brevity as these features are known.

Although the description and discussion were in reference to certain exemplary embodiments of the present disclosure, numerous additions, modifications and variations will be readily apparent to those skilled in the art. The scope of the invention is given by the following claims, rather then the preceding description, and all additions, modifications, variations and equivalents that fall within the range of the stated claims are intended to be embraced therein.

1. A spectrum sensing method in a communication system comprising:
sensing a shared spectrum with a plurality of cognitive radios;
switching non interfering cognitive radios and cooperative secondary users to a non-cooperative mode;
keeping a record of a number of times a result of spectrum sensing of a cognitive radio matches a result of cooperative sensing;
setting a threshold in a shift register value to determine when to switch between cooperative and non-cooperative sensing modes based on comparing the shift register value to the threshold; and
sending a control message to provide a non-cooperative cognitive radio access to the spectrum.

2. The method of claim 1 wherein the spectrum is a wireless radio frequency spectrum.

3. The method of claim 1, wherein the switching is performed, regardless of a cooperative sensing result.

4. The method of claim 1, wherein the keeping includes keeping a record in a shift register.

5. The method of claim 1, wherein the plurality of cognitive radios include cooperative and non-cooperative cognitive radios in a same network.

6. The method of claim 1 further comprising avoiding interference from a non-cooperative cognitive radio to a primary system and cooperative cognitive radios by sending a broadcast message.

7. The method of claim 1 further comprising:
avoiding interference from a non-cooperative cognitive radio to a primary system and cooperative cognitive radios by sending a broadcast message from the non-cooperative cognitive radio to neighboring cognitive radios whenever the non-cooperative cognitive radio senses that the spectrum is available.

8. The method of claim 7 further comprising:
sending reply messages from neighboring cognitive radios to the non-cooperative cognitive radio in response to the broadcast message.

9. The method of claim 7 further comprising:
sending reply messages from neighboring cognitive radios to the non-cooperative cognitive radio in response to the broadcast message, wherein respective reply messages contain information on whether transmission from a non-cooperative cognitive radio causes harmful interference.

10. The method of claim 1 further comprising:
avoiding interference to a primary user or cooperative cognitive radios by using two antennas for each cognitive radio, wherein one antenna is for transmission over a certain channel and the other antenna is for sending control message.

11. The method of claim 10, wherein control messages comprise broadcast messages and reply messages.

12. A spectrum sensing apparatus in a communication system comprising:
a plurality of cognitive radios each including a sensor to sense a shared spectrum;
a switch configured to change an operational mode of a portion of the plurality of cognitive radios that are not interfering with a primary system and cooperative cognitive radios to a non-cooperative mode;
a plurality of shift registers on the cognitive radios to keep record of a number of times a result of spectrum sensing of a cognitive radio matches a result of cooperative sensing;
comparator circuitry configured to compare the shift register values to a threshold to determine if the switch should change the mode between cooperative and a non-cooperative sensing; and
a plurality of transmitter antennas configured to send a control message to provide a non-cooperative cognitive radio access to the shared spectrum.

13. The apparatus of claim 12, wherein cognitive radios each have two antennas to separate broadcast and reply messages.

14. The apparatus of claim 12, wherein the spectrum is a wireless radio frequency spectrum.

15. A non-transitory computer-readable storage medium including computer executable instructions, wherein the instructions, when executed by a computer, cause the computer to perform a method of sensing, the method comprising:
sensing a shared spectrum with a plurality of cognitive radios;
switching non interfering cognitive radios and cooperative secondary users to a non-cooperative mode;
keeping a record of a number of times a result of spectrum sensing of a cognitive radio matches a result of cooperative sensing; setting a threshold in a shift register value to determine when to switch between cooperative and non-cooperative sensing modes based on comparing the shift register value to the threshold; and
sending a control message to provide a non-cooperative cognitive radio access to the shared spectrum.

16. The method of claim 15, wherein the switching is performed, regardless of a cooperative sensing result.

17. The method of claim 15, wherein the keeping includes keeping a record in a shift register.

18. The methods of claim 15 further comprising:
avoiding interference to a primary user or cooperative cognitive radios by using two antennas for each cognitive radio, wherein one antenna is for transmission over a predetermined channel and the other antenna is for sending control messages, wherein the control messages include broadcast messages and reply messages.

19. The method of claim 15 further comprising:
avoiding interference from a non-cooperative cognitive radio to a primary system and cooperative cognitive radios by sending a broadcast message from the non-cooperative cognitive radio to neighboring cognitive radios whenever the non-cooperative cognitive radio senses that the spectrum is available.

20. The method of claim 15 further comprising:
sending reply messages from neighboring cognitive radios to the non-cooperative cognitive radio in response to the broadcast message, wherein respective reply messages contain information on whether transmission from a non-cooperative cognitive radio causes harmful interference.
